(19) United States
(12) Patent Application Publication
(10) Pub. No.: US 2015/0077780 A1
(43) Pub. Date: Mar. 19, 2015

(54) IMAGE FORMING APPARATUS, IMAGE FORMING METHOD, AND PROGRAM

(71) Applicant: Konica Minolta Inc., Tokyo (JP)

(72) Inventor: Masaharu HARASHIMA, Tokyo (JP)

(21) Appl. No.: 14/488,849

(22) Filed: Sep. 17, 2014

(30) Foreign Application Priority Data
Sep. 18, 2013 (JP) 2013-193167

(51) Int. Cl. H04N 1/00; H04N 1/23

(52) U.S. Cl. CPC H04N 1/00482; H04N 1/00912; H04N 1/2392; H04N 1/00798; H04N 2201/0094
USPC 358/1.13; 358/1.15

(57) ABSTRACT

An image forming apparatus includes: a reception section configured to receive a prescribed mode; a display section configured to display a plurality of parts or units based on the prescribed mode received by the reception section; and an image forming section configured to change a setting value of a setting item and to print an image on a piece of paper when any one of the plurality of parts or units displayed on the display section is selected, the setting item being assigned to the selected part or unit.

The entire disclosure of Japanese Patent Application No. 2013-193167 filed with the Japan Patent Office on Sep. 18, 2013 including description, claims, drawings, and abstract are incorporated herein by reference in its entirety.

### BACKGROUND OF THE INVENTION

1. Field of the Invention

The present invention relates to an image forming apparatus, an image forming method, and a program.

2. Description of the Related Art

Conventionally, in a case where a part such as consumables or the like of an image forming apparatus reaches a time for replacement or a case where a defect of an image is caused, replacement of a corresponding part has been performed by a service person or the like. In JP 2010-266757 A, an image forming apparatus is described. When a reused product is used for replacement of consumables such as a part of the image forming apparatus, the image forming apparatus changes setting to an appropriate setting corresponding to the consumables after the replacement with the reused consumables is performed.

However, in conventional replacement of a part described, for example, in JP 2010-266757 A, there is the following problem. That is, conventionally, to make a down-time short as much as possible, replacement of a part is performed lightly when a defect of an image or the like is caused. However, in such a case, by adjusting a setting value of each setting item assigned to a part to be replaced, a defect of an image or the like which is a problem may be improved. Thus, conventionally, there has been a problem that replacement of apart is performed even in a case which can be dealt with without the replacement of a part and that replacement of a part is performed unnecessarily.

### SUMMARY OF THE INVENTION

Thus, in the view of the forgoing problem, the present invention has been made to provide an image forming apparatus, an image forming method, and a program which make it possible to prevent replacement of a part from being performed lightly when a defect of an image or the like is caused.

To achieve the above object, according to an aspect, an image forming apparatus reflecting one aspect of the present invention includes: a reception section configured to receive a prescribed mode; a display section configured to display a plurality of parts or units based on the prescribed mode received by the reception section; and an image forming section configured to change a setting value of a setting item and to print an image on apiece of paper when any one of the plurality of parts or units displayed on the display section is selected, the setting item being assigned to the selected part or unit.

Also, an image forming method reflecting one aspect of the present invention includes: receiving a prescribed mode; displaying a plurality of parts or units based on the received prescribed mode; and changing a setting value of a setting item and printing an image on a piece of paper when any one of the plurality of parts or units is selected, the setting item being assigned to the selected part or unit.

Also, a non-transitory recording medium storing a computer readable program reflecting one aspect of the present invention makes a computer execute a step of receiving a prescribed mode, a step of displaying a plurality of parts or units based on the received prescribed mode, and a step of changing a setting value of a setting item and printing an image on a piece of paper when any one of the plurality of parts or units is selected, the setting item being assigned to the selected part or unit.

### BRIEF DESCRIPTION OF THE DRAWINGS

The above and other objects, advantages and features of the present invention will become more fully understood from the detailed description given hereinbelow and the appended drawings which are given byway of illustration only, and thus are not intended as a definition of the limits of the present invention, and wherein:

FIG. 1 is a view illustrating an example configuration of an image forming apparatus according to an embodiment of the present invention;

FIG. 2 is a view illustrating an example block configuration of an image forming apparatus according to a first embodiment of the present invention;

FIG. 3 is a flowchart illustrating an example operation of the image forming apparatus;

FIG. 4 is a view illustrating an example configuration of an operation screen displayed on a display section;

FIG. 5 is a view illustrating an example configuration of a part selection screen displayed on the display section;

FIG. 6 is a view illustrating an example block configuration of an image forming apparatus according to a second embodiment of the present invention;

FIG. 7 is a flowchart illustrating an example operation of the image forming apparatus;

FIGS. 8A to 8E are views for describing an image and identification information which are printed in each condition;

FIG. 9 is a view illustrating an example configuration of a comparison result screen displayed on a display section;

FIG. 10 is a view for describing a case where a plurality of images is printed on one piece of paper;

FIG. 11 is a view illustrating an example configuration of a defect selection screen displayed on a display section of an image forming apparatus according to a third embodiment of the present invention; and

FIG. 12 is a view illustrating an example configuration of a part selection screen displayed on the display section.

### DESCRIPTION OF THE PREFERRED EMBODIMENTS

Hereinafter, an embodiment of the present invention will be described with reference to the drawings. However, the scope of the invention is not limited to the illustrated examples.

In the following, preferred embodiments of the present disclosure will be described in detail with reference to the attached drawings. Note that a proportion of the drawings is stretched for convenience of description and may be different from an actual proportion.

### First Embodiment

### Example Configuration of Image Forming Apparatus

First, an image forming apparatus 100 according to an embodiment of the present invention (hereinafter, may be referred to as image forming apparatus 100A, 100B, and 100C) will be described. When a defect of an image is caused and a part or a unit, which is a cause of the defect, is to be replaced, the image forming apparatus 100 executes a part replacement mode to give a user an opportunity to determine whether the replacement of a part is really necessary. Thus, the image forming apparatus 100 can prevent lightly-performed replacement of a part or the like.

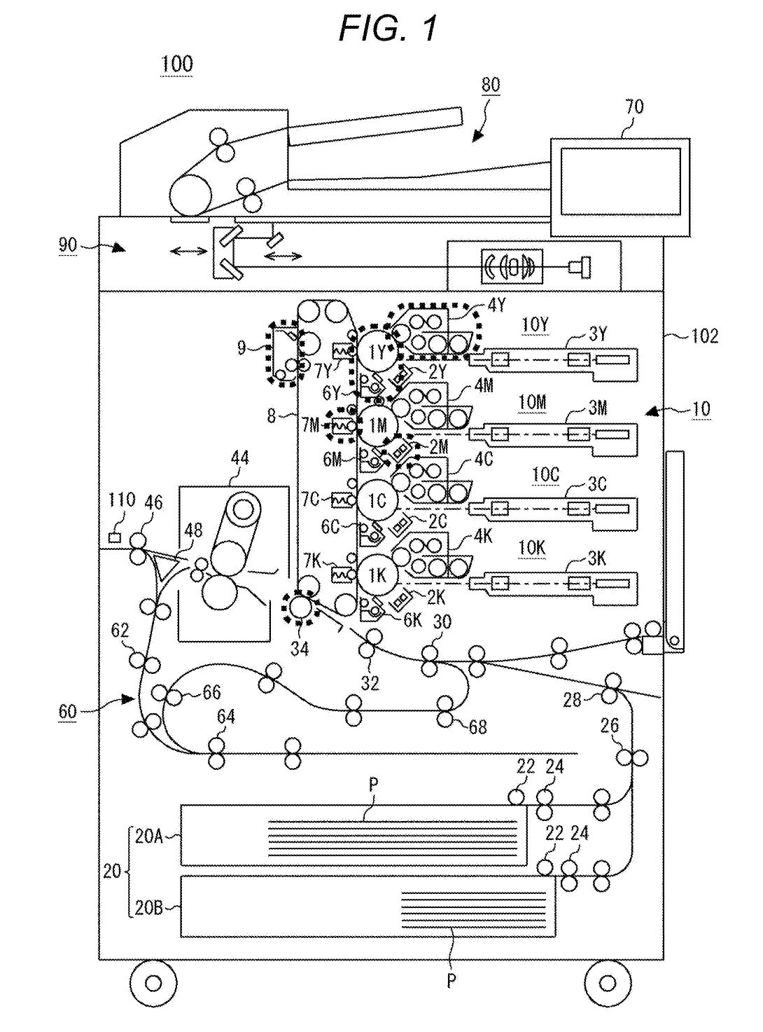

FIG. 1 is a view illustrating an example of a configuration of the image forming apparatus 100 according to an embodiment of the present invention. As illustrated in FIG. 1, the image forming apparatus 100 is called a tandem-type image forming apparatus and includes an automatic document feeding section 80 and an apparatus main body 102. The automatic document feeding section 80 is attached to an upper part of the apparatus main body 102 and feeds, with a feeding roller or the like, paper set on a feeding table to an image reading section 90 of the apparatus main body 102.

The apparatus main body 102 includes an operation display section 70, an image reading section 90, an image forming section 10, an intermediate transfer belt 8, a paper feeding section 20, a fixing section 44, an auto duplex unit 60 (hereinafter, referred to as ADU), and a reading section 110.

The operation display section 70 includes a touch panel in which an operation section and a display section are combined. The operation display section 70 receives various selections of an image forming condition such as a paper type or a size and of a part replacement mode and displays an input screen to receive such various selections.

The image reading section 90 performs scanning exposure, with an optical system of a scanning exposure apparatus, on a document placed on a platen or a document fed by the automatic document feeding section 80. Then, the image reading section 90 photoelectrically converts an image of the scanned document with a charge coupled devices (CCD) image sensor and generates an image information signal. The image information signal is output to the image forming section 10, after analog processing, analog/digital (hereinafter referred to as A/D) conversion processing, a shading correction, image compression processing, or the like is performed by an image processing section (not illustrated).

The image forming section 10 forms an image by an electrophotographic method. The image forming section 10 includes an image forming unit 10Y which forms an image having yellow (Y), an image forming unit 10M which forms an image having magenta (M), an image forming unit 10C which forms an image having cyan (C), and an image forming unit 10K which forms an image having black (K). In this example, Y, M, C, and K indicating forming colors are assigned behind a common function name, such as the reference sign 10.

The image forming unit 10Y includes a photoreceptor drum 1Y, an electrifier 2Y arranged therearound, an exposure section (optical writing section) 3Y, a developing device 4Y, and a cleaning section 6Y. The image forming unit 10M includes a photoreceptor drum 1M, an electrifier 2M arranged therearound, an exposure section 3M, a developing device 4M, and a cleaning section 6M. The image forming unit 10C includes a photoreceptor drum 1C, an electrifier 2C arranged therearound, an exposure section 3C, a developing device 4C, and a cleaning section 6C. The image forming unit 10K includes a photoreceptor drum 1K, an electrifier 2K arranged therearound, an exposure section 3K, a developing device 4K, and a cleaning section 6K.

The photoreceptor drums (image carrier) 1Y, 1M, 1C, and 1K, the electrifier 2Y, 2M, 2C, and 2K, the exposure sections 3Y, 3M, 3C, and 3K, the developing devices 4Y, 4M, 4C, and 4K, and the cleaning sections 6Y, 6M, 6C, and 6K in the image forming units 10Y, 10M, 10C, and 10K respectively include common configurations. In the following, Y, M, C, and K are not assigned except when distinction is particularly necessary.

The electrifier 2 almost uniformly electrifies a surface of the photoreceptor drum 1. The exposure section 3 includes, for example, an LED print head (LPH) including an LED array and an imaging lens or a laser exposure scanning apparatus in a polygon mirror method. The exposure section 3 scans the photoreceptor drum 1 with a laser beam based on the image information signal and forms an electrostatic latent image. The developing device 4 develops, with toner, the electrostatic latent image formed on the photoreceptor drum 1. Thus, a toner image which is a visible image is formed on the photoreceptor drum 1.

An intermediate transfer belt 8 is stretched and rotatably supported by a plurality of rollers. To the intermediate transfer belt 8, a cleaning unit 9 to clean the intermediate transfer belt 8 is provided. Along with turning of the intermediate transfer belt 8, a primary transfer roller 7 and the photoreceptor drum 1 rotate. Thus, a prescribed voltage is applied between the primary transfer roller 7 and the photoreceptor drum 1 and the toner image formed on the photoreceptor drum 1 is transferred on the intermediate transfer belt 8 (primary transfer).

In the present example, parts and units of the electrifier 2, the developing device 4, a drum unit including the photoreceptor drum 1, the primary transfer roller 7, the cleaning unit 9, and the secondary transfer roller 34 which are surrounded by dashed lines in FIG. 1 are configured in a replaceable manner. In respect to the electrifier 2, the developing device 4, the drum unit, and the primary transfer roller 7, Y, M, C, and K are configured in a respectively replaceable manner.

The paper feeding section 20 includes a plurality of paper feeding trays 20A and 20B storing paper M which is, for example, A3 or A4-sized. Paper P which is fed from each of the paper feeding trays 20A and 20B by feeding rollers 22, 24, 26, 28, or the like passes through a loop generating roller 30 and is fed to a resist roller 32. Note that the number of paper feeding trays is not limited to two. Also, when necessary, a single or a plurality of large capacity paper feeding apparatuses which can store a great number of pieces of paper P may be coupled.

The resist roller 32 includes a drive roller and a driven roller and a leading end of the paper P is butted thereto by the loop generating roller 30. Thus, the resist roller 32 forms a loop and corrects skewing of the paper P. The paper P is fed to a secondary transfer roller 34 at a prescribed timing. In the secondary transfer roller 34, Y, M, C, and K toner images transferred on the intermediate transfer belt 8 are transferred at once on a surface of the paper P fed by the resist roller 32 (secondary transfer). The paper P on which the secondary transfer is performed is fed to a fixing section 44 on a downstream side in a paper feeding direction.

The fixing section 44 includes a pressure roller and a heating roller. The fixing section 44 fixes the toner image, which is on the surface of the paper P, to the paper P by performing pressing/heating processing on the paper P on which the toner image is transferred by the secondary transfer roller 34.

On the downstream side in the paper feeding direction of the fixing section 44, a feeding path switching section 48 to switch a feeding path of the paper P to a paper ejection path side or the ADU 60 side. Based on a selected printing mode (such as one-side printing mode or both-sides printing mode), the feeding path switching section 48 performs switching control of the feeding path.

The paper P on which the printing of one side is over in the one-side printing mode or the paper P on which the printing of both sides is over in the both-sides printing mode is ejected on a paper ejection tray by a paper ejection roller 46.

Also, in the both-sides printing mode, when the paper P on which an image is formed on a front surface side is fed to the image forming section 10 again, the paper P on which the image is formed on the front surface side is fed to the ADU 60 through the feeding path switching section 48. The paper P fed to the ADU 60 is fed to a switch back path through a feeding roller 62 or the like. In the switch back path, by reverse rotation control of an ADU roller 64, the paper P is fed to a U-turn path section with a rear end thereof as a head. Then, by feeding rollers 66, 68, or the like provided to the U-turn path section, the paper P is fed to the resist roller 32 again with the front side and the rear side thereof being reversed. On the paper P fed to the resist roller 32 again, image forming processing similar to that performed on the front surface side of the paper P. The paper P on which an image is transferred on the rear surface by the image forming section 10 is ejected on the paper ejection tray through the feeding path switching section 48 and the paper ejection roller 46 after fixing processing is performed by the fixing section 44.

The reading section 110 includes, for example, a line sensor in which photoelectric conversion elements are arranged in a line or an image sensor in which photoelectric conversion elements are arranged in a matrix. The reading section 110 is provided to a downstream side in a paper feeding direction of the paper ejection roller 46 and reads the image on the paper P on which the fixing processing is performed by the fixing section 44. Note that the reading section 110 is not necessarily limited to the above arrangement as long as being arranged on the downstream side of the fixing section 44. For example, the reading section 110 may be arranged on an upstream side of the paper ejection roller 46.

### Example Block Configuration of Image Forming Apparatus

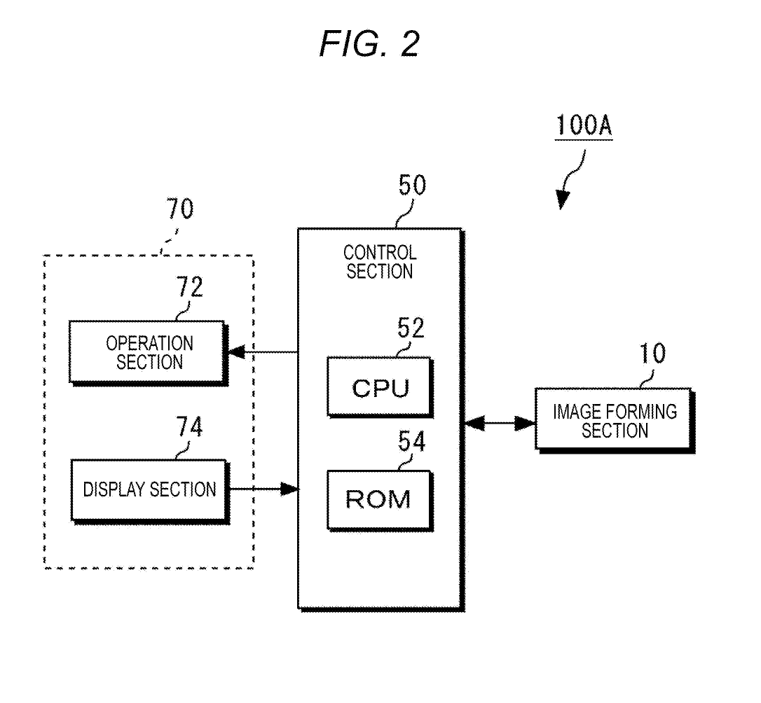

Next, an image forming apparatus 100A according to the first embodiment will be described. FIG. 2 is a block diagram illustrating an example of a functional configuration of the image forming apparatus 100A. As illustrated in FIG. 2, the image forming apparatus 100A includes a control section 50 including a central processing unit (CPU) 52, a read only memory (ROM) 54, or the like. By executing software (program) read from the ROM 54, the CPU 52 controls each section of the image forming apparatus 100A and realizes a function related to a part replacement mode or image forming. Note that when executing the program, the CPU 52 uses data recorded into the ROM 54.

Note that a program of the present technique is, for example, a program which can be provided to a general computer, which can execute various program codes, by a storage medium such as an optical disk, a magnetic disk, or a semiconductor memory or by a communication medium such as a network. By providing such a program in a form which can be executed by a computer, processing corresponding to a program such as a part replacement mode can be executed on the computer.

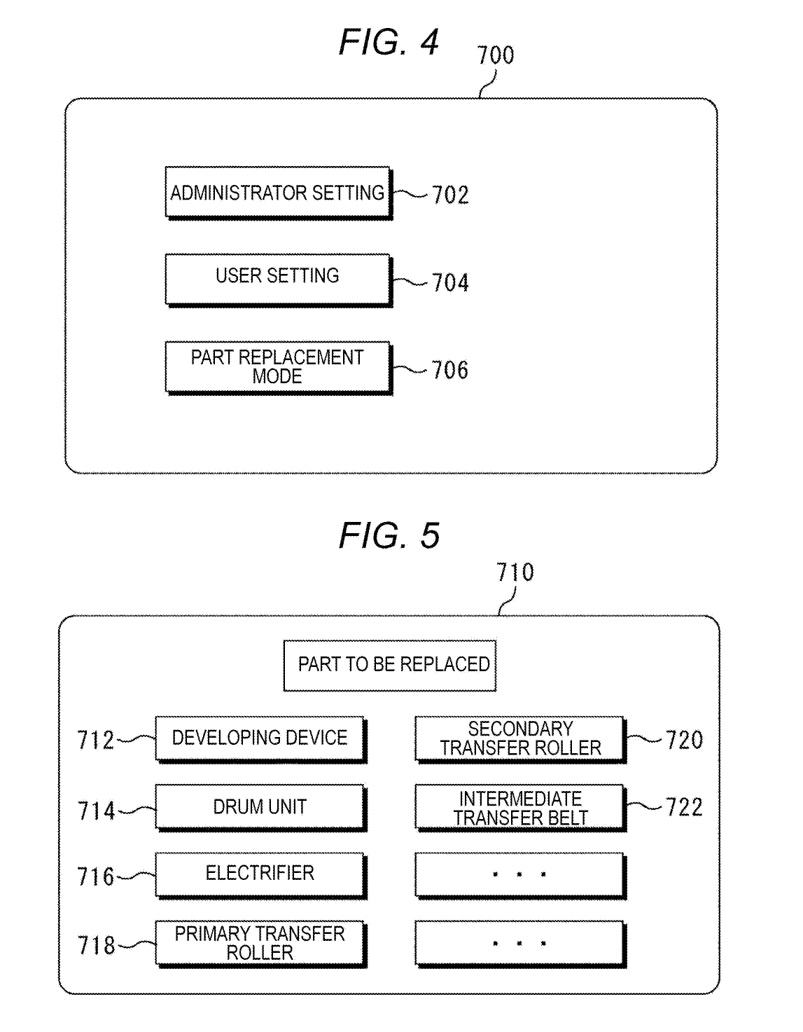

To the control section 50, the operation display section 70 and the image forming section 10 are connected. The operation display section 70 includes an operation section 72 and a display section 74. The display section 74 displays an operation screen (see FIG. 4) for selection of a part replacement mode or the like or a part selection screen (see FIG. 5) for a user to select a part or the like to be replaced in the part replacement mode. The operation section 72 is an example of a reception section. The operation section 72 receives, on the operation screen, selection of the part replacement mode or the like or receives, on the part selection screen, selection of a part or the like to be replaced.

In a case where a part or a unit to be replaced is selected in the execution of the part replacement mode, the image forming section 10 changes a setting value of each setting item related to the selected part or the like and generates print data corresponding to the changed setting value. Then the image forming section 10 forms a prescribed image on the paper P based on the generated print data. The image formed on the paper P in the part replacement mode may be, for example, an image used in printing of a last job or an image of a special pattern provided for the part replacement mode. When the special pattern is used, only an image necessary for checking the image needs to be printed. Thus, a wasted toner or the like can be reduced.

### Example Operation of Image Forming Apparatus

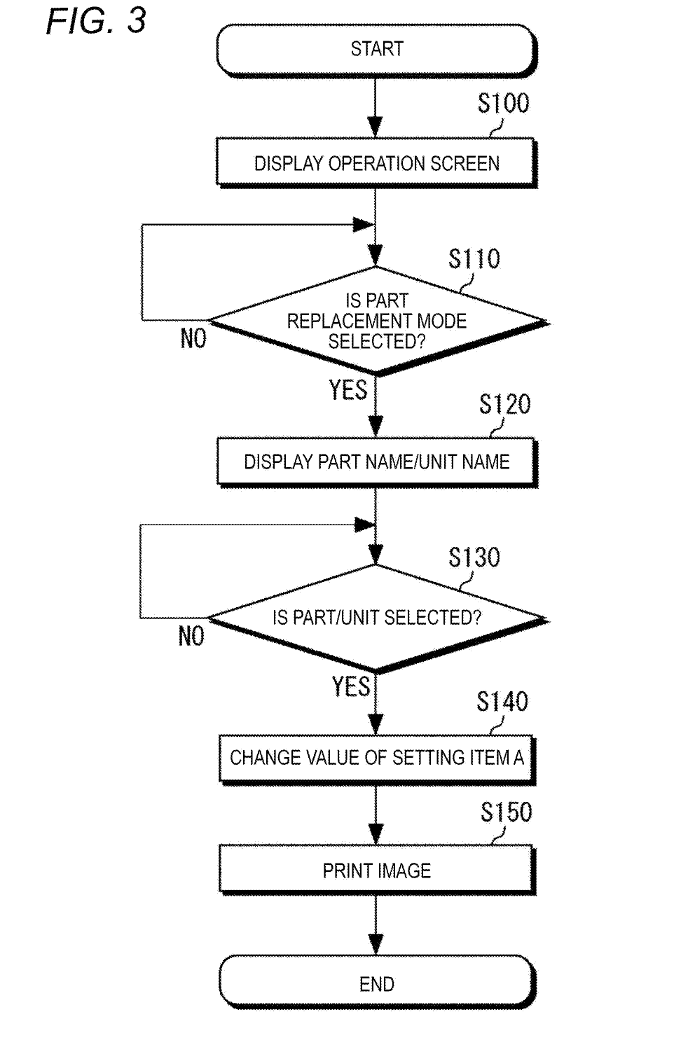

Next, an example operation of the image forming apparatus 100A according to the first embodiment of the present invention will be described. FIG. 3 is a flowchart illustrating an example of an operation of the image forming apparatus 100A when the part replacement mode is executed. By executing the program stored in the ROM 54, the CPU 52 realizes processing corresponding to a flowchart illustrated in FIG. 3. Note that other than a case of replacing a single part, the part replacement mode includes a case of replacing a unit including a plurality of parts. However, for a convenience, in the present invention, a mode corresponding to replacement of a single part or a unit is called the part replacement mode. Also, in the following, a part or a unit may be simplified and simply called a part or the like.

For example, as illustrated in FIG. 3, in step S100, when the power of the image forming apparatus 100A is turned on, the control section 50 displays, on the operation display section 70, an operation screen 700 to perform prescribed setting. FIG. 4 is a view illustrating an example of a configuration of the operation screen 700. As illustrated in FIG. 4, on the operation screen 700, a button 702 to select “administrator setting”, a button 704 to select “user setting”, and a button 706 to select a “part replacement mode” are displayed. Note that the operation screen 700 may be automatically displayed on the operation display section 70 in response to the power being turned on or may be displayed on the operation display section 70 in response to a prescribed key (not illustrated), which is included in the operation section 72, being pressed by a user.

In step S110, the control section 50 determines whether the button 706 corresponding to the “part replacement mode” is selected by a user operation on the operation screen 700. When determining that the button 706 corresponding to the “part replacement mode” is selected, the control section 50 goes to step S120. On the other hand, when determining that the button 706 corresponding to the “part replacement mode” is not selected, the control section 50 waits until the button 706 is selected. Note that when a different button such as the “user setting” is selected on the operation screen 700, processing corresponding to the selected button is executed. However, a description of the processing in the case is omitted.

In step S120, when the button 706 corresponding to the “part replacement mode” is selected on the operation screen 700, the control section 50 displays, on the operation display section 70, a part selection screen 710 to select a part or a unit to be replaced.

FIG. 5 is a view illustrating an example of a configuration of the part selection screen 710. On the part selection screen 710, a list of buttons indicating a plurality of part names and unit names is displayed. Specifically, a button 712 to select a developing device, a button 714 to select a drum unit, a button 716 to select an electrifier, a button 718 to select a primary transfer roller, a button 720 to select a secondary transfer roller, and a button 722 to select an intermediate transfer belt are displayed. Note that a part or the like displayed on the part selection screen 710 is not limited to the kinds described above.

In step S130, the control section 50 determines whether a button corresponding to a particular part or unit to be replaced is selected by a user on the part selection screen 710. When determining that a button corresponding to a part or the like to be replaced is selected on the part selection screen 710, the control section 50 goes to step S140. On the other hand, when a button corresponding to a part or the like to be replaced is not selected, the control section 50 waits until the button corresponding to the part or the like is selected.

In the following, a description will be made on the assumption that the button 712 corresponding to the “developing device” is selected by a user on the part selection screen 710 illustrated in FIG. 5.

In step S140, when the button assigned to the part or the like to be replaced is selected on the part selection screen 710, the control section 50 changes a setting value of a setting item A related to the selected part or the like from a current value at the selection. In a case where the part or the like to be replaced is the “developing device”, the setting item A is, for example, at least one of a “fine adjustment of a developing bias”, an “adjustment of toner density”, a “fine adjustment of a developing AC frequency”, and a “fine adjustment of a fog margin (difference between potential of unexposed section of photoreceptor drum and potential of developing bias)”. In respect to the “fine adjustment of a developing bias” which is the setting item A, the control section 50 changes, with a current value as a reference, a setting value of a voltage of a developing bias either in a direction to increase the value or in a direction to decrease the value. Also, when the “adjustment of toner density”, the “fine adjustment of a developing AC frequency”, and the “fine adjustment of a fog margin” are included in the setting item A, similarly to the “fine adjustment of a developing bias”, the control section 50 changes corresponding setting values either in a direction to increase the values or in a direction to decrease the values with the current value as a reference.

In step S150, by controlling the image forming section 10 or the like based on the changed setting value of the setting item A of the part or the like to be replaced, the control section 50 prints an image on the paper P. Thus, for example, by changing the setting value of the voltage of the developing bias of the developing device 4 either in a direction to increase the value or in a direction to decrease the value and by printing an image, a defect may be improved compared to an image printed in an original setting value of the voltage of the developing bias.

As described above, according to the first embodiment, in replacement of a part of when a defect of an image is caused, by checking an image printed based on a changed setting value, it is possible to determine that the replacement of a part is not necessary when the image is improved. Thus, by reflecting the changed setting value on subsequent printing of an image, it is possible to deal with a defect of an image without replacing a part. As a result, unnecessary replacement of a part or the like can be reduced, and thus, a cost can be reduced.

### Second Embodiment

The second embodiment is different from the first embodiment in a point that images before and after a change in a setting value of each setting item of a part or a unit are compared by a control section 50. Note that other configurations and operations of an image forming apparatus 100 are similar to those in the first embodiment. Thus, the same reference sign is assigned to common configuration elements and a detail description thereof is omitted.

### Example Block Configuration of Image Forming Apparatus

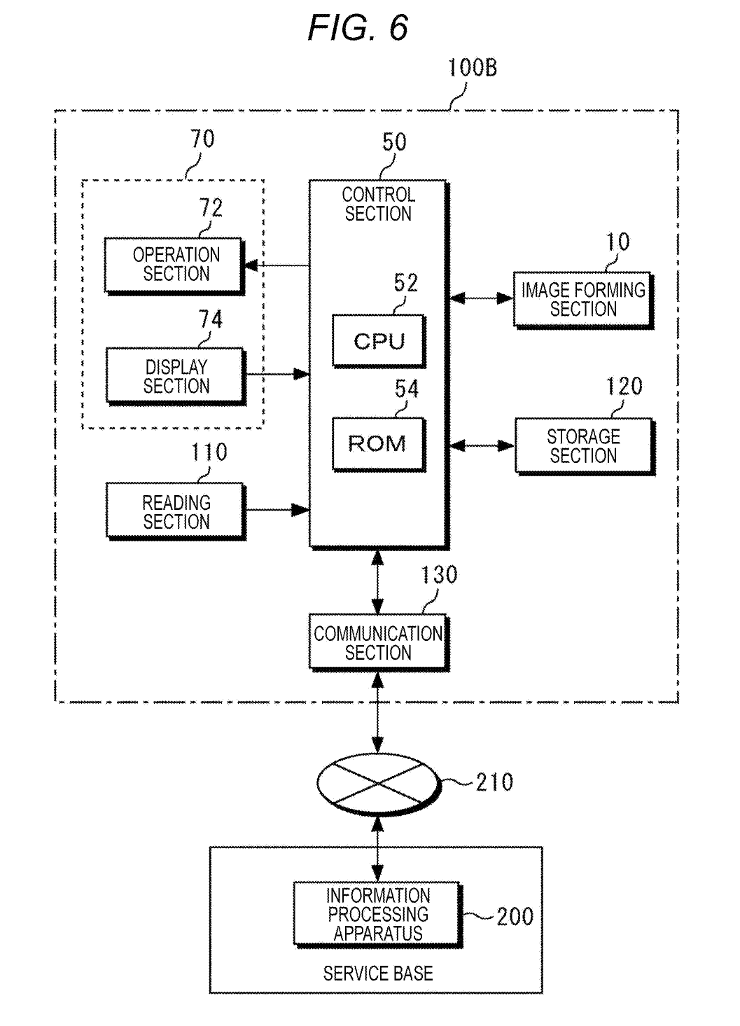

First, an example block configuration of an image forming apparatus 100B according to the second embodiment will be described. FIG. 6 is a block diagram illustrating an example of a functional configuration of the image forming apparatus 100B. As illustrated in FIG. 6, the image forming apparatus 100B includes a control section 50 including a CPU 52, a ROM 54, or the like. By executing software (program) read from the ROM 54, the CPU 52 controls each section of the image forming apparatus 100B and realizes a function related to a part replacement mode or image forming processing. Note that when executing the program, the CPU 52 uses data recorded into the ROM 54.

To the control section 50, an operation display section 70, a reading section 110, an image forming section 10, a storage section 120, and a communication section 130 are connected.

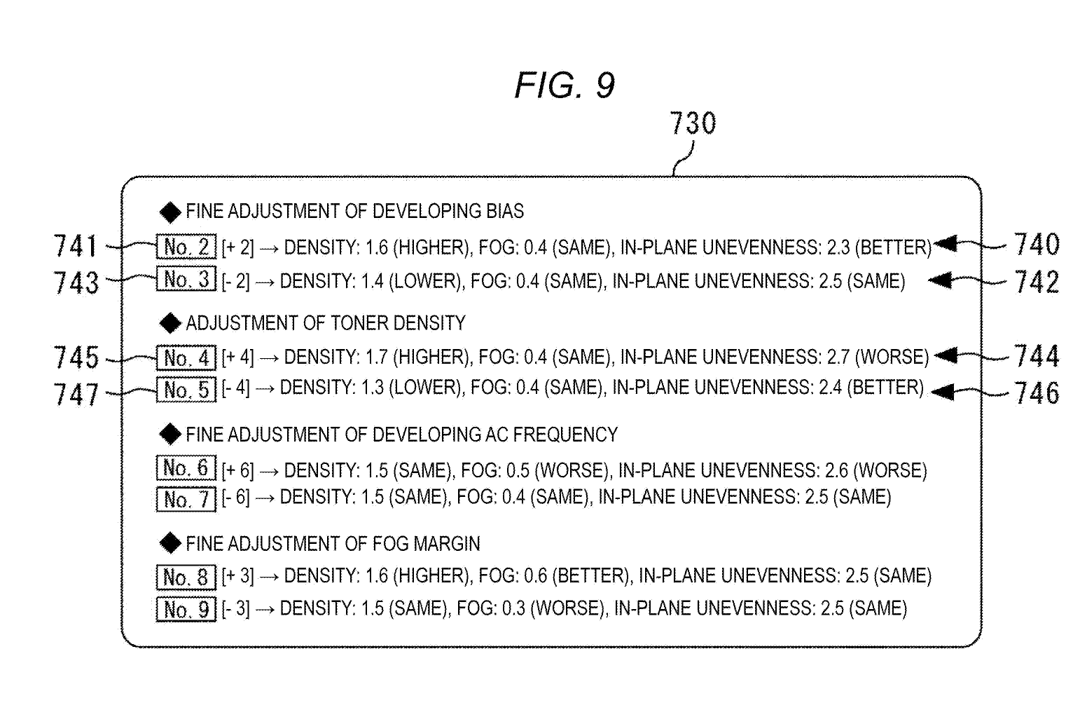

The operation display section 70 includes an operation section 72 and a display section 74. Other than the described operation screen (see FIG. 4) or part selection screen (see FIG. 5), the display section 74 displays a screen (see FIG. 9) indicating a comparison result between a print image before a change in a setting value of a setting item related to a selected part or the like (according to current setting value) and a print image after the change in the setting value of the setting item related to the selected part or the like (according to changed setting value). The operation section 72 receives, on an operation screen, selection of a part replacement mode or the like based on a user operation or receives, on a part selection screen, selection of a part or the like to be replaced.

In execution of a part replacement mode, the reading section 110 reads an image printed in a current setting value of each setting item related to a part to be replaced and an image printed in a changed setting value. The reading section 110 supplies, to the control section 50, the read data of the images in each setting value before and after the change.

When a part or a unit to be replaced is selected by a user in the part replacement mode, the image forming section 10 performs image forming on paper P based on a current setting value and a changed setting value of a setting item related to the selected part or the like.

The storage section 120 includes, for example, a nonvolatile semiconductor memory, a hard disk drive (HDD), or the like. The storage section 120 stores, for example, image forming condition information, such as a paper type or a size, related to a job, and image data in a current setting value and a changed setting value of a setting item related to a part or the like to be replaced, the image data being read by the reading section 110 in the part replacement mode. The storage section 120 stores a reference value which is used when images before and after a change in a setting value are compared in the part replacement mode. The reference value includes reference values respectively related to toner density, a fog (defectively electrified toner adhered to background section of image formed on surface of photoreceptor drum or the like), and in-plane unevenness.

The communication section 130 is connected, through a network 210, to an information processing apparatus 200 provided outside. As a communication protocol, an HTTP/HTTPS, an SMTP, or the like can be used. The communication section 130 transmits, to the information processing apparatus 200, selection information indicating a part name or a unit name selected by a user in the part replacement mode or comparison result information (see FIG. 9) indicating a comparison result between images before and after a change in a setting value in the part replacement mode.

The information processing apparatus 200 includes, for example, a computer or the like including a display section, an operation section, or the like and is provided to a service base or the like where a service person always stays. The information processing apparatus 200 receives comparison result information or the like in the part replacement mode, which information or the like is transmitted from the image forming apparatus 100B through the network 210, and displays the comparison result on the display section. Also, information processing apparatus 200 displays an operation screen 700, a part selection screen 710, or the like related to the part replacement mode and performs remote control by transmitting, to the image forming apparatus 100B, execution/non-execution of the part replacement mode or selection information of a part or the like to be replaced.

### Example Operation of Image Forming Apparatus

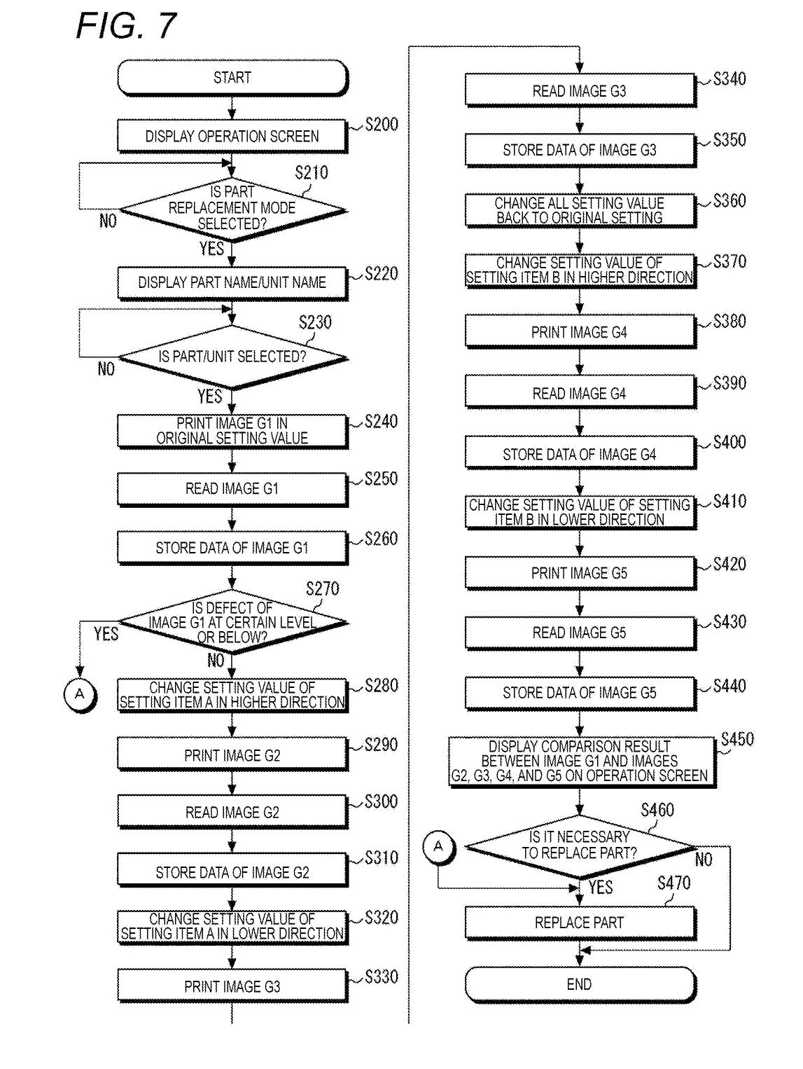

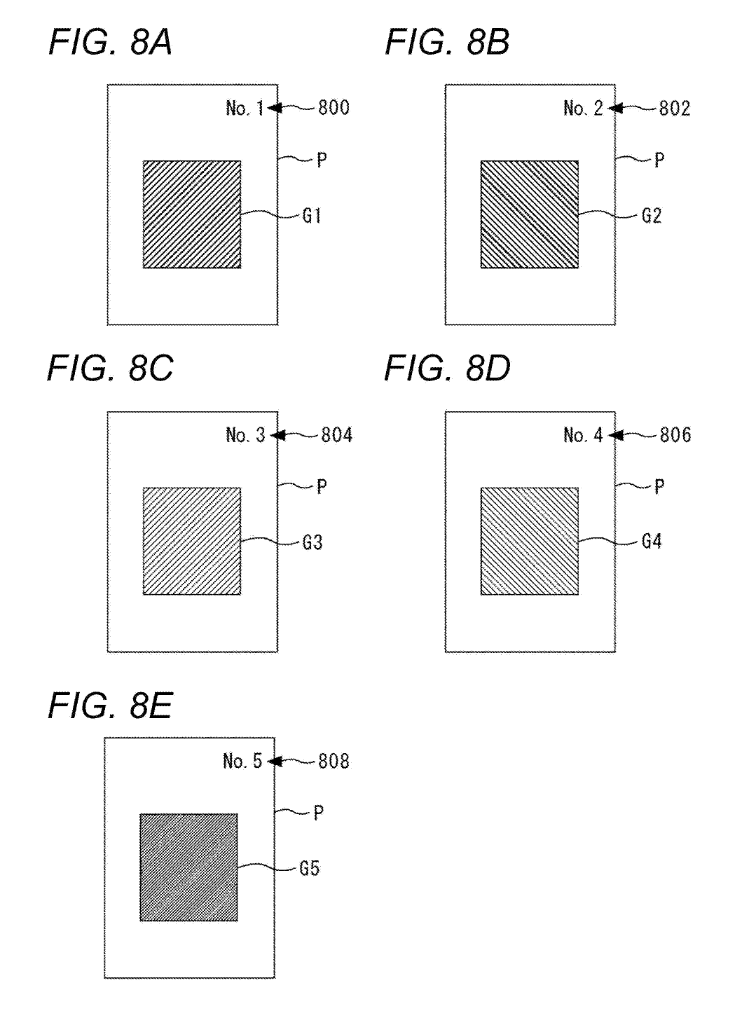

Next, an example operation of the image forming apparatus 100B according to the second embodiment of the present invention will be described. FIG. 7 is a flowchart illustrating an example of an operation of the image forming apparatus 100B in a case where the part replacement mode is selected. By executing the program stored in the ROM 54, the CPU 52 realizes processing corresponding to the flowchart illustrated in FIG. 3. Each of FIG. 8A to FIG. 8E is a view illustrating an example of an image printed on the paper P in each setting value of a setting item (in the present example, fine adjustment of developing bias). Note that processing from step S200 to step S230 is similar to the processing from step S100 to step S130 which is illustrated in FIG. 3 and is described in the first embodiment, and thus, a description thereof is simplified.

As illustrated in FIG. 7, in step S200, when the power of the image forming apparatus 100B is turned on, the control section 50 displays, on the operation display section 70, the operation screen 700 (see FIG. 4) to perform prescribed setting.

In step S210, the control section 50 determines whether a button 706 corresponding to the “part replacement mode” is selected by a user operation on the operation screen 700. When determining that the button 706 corresponding to the “part replacement mode” is selected, the control section 50 goes to step S220 and when determining that the button 706 corresponding to the “part replacement mode” is not selected, for example, the control section 50 waits until the button 706 is selected.

In step S220, when the button 706 corresponding to the “part replacement mode” is selected, the control section 50 displays, on the operation display section 70, the part selection screen 710 (see FIG. 5) to select a part or the like to be replaced.

In step S230, the control section 50 determines whether a button corresponding to a part or the like to be replaced is selected on the part selection screen 710. When determining that the button corresponding to the part or the like to be replaced is selected, the control section 50 goes to step S240. In the present example, an example in a case where a button 712 corresponding to a “developing device” in FIG. 5 is selected will be described. On the other hand, when the button corresponding to the part or the like to be replaced is not selected, the control section 50 waits until the button corresponding to the part or the like is selected.

In step S240, when the button corresponding to the part to be replaced is selected on the part selection screen 710, the control section 50 prints an image G1 by controlling the image forming section 10 or the like based on a current (when defect is caused) setting value of each setting item assigned to the selected part. In the present embodiment, a current setting value of each setting item is called a first condition. Specifically, as illustrated in FIG. 8A, No. 1 which is identification information 800 to indicate the first condition is printed on the paper P along with the image G1 being printed thereon based on the first condition. In a case where the selected part is the “developing device”, as described above, the setting item includes a “fine adjustment of a developing bias”, an “adjustment of toner density”, a “fine adjustment of a developing AC frequency”, and a “fine adjustment of a fog margin”.

In step S250, the reading section 110 reads the image G1 printed on the paper P fed by a paper ejection roller 46. In step S260, the control section 50 stores, into the storage section 120, data of the image G1 on the paper P which data is read by the reading section 110.

In step S270, the control section 50 determines whether a defect of the image G1 printed on the paper P is at a certain level or below. The control section 50 reads the data of the image G1 stored in the storage section 120 and calculates a numerical value to each reference value, for example, in toner density, a fog, and in-plane unevenness of the read image G1. When the calculated numerical value of each of the toner density, the fog, and the in-plane unevenness does not exceed a permissible range of the reference value, the control section 50 determines that the defect of the image G1 is not at the certain level or below and goes to step S280.

On the other hand, when the calculated numerical value of at least one of the toner density, the fog, and the in-plane unevenness exceeds the permissible range of the reference value, the control section 50 determines that the defect of the image G1 is at the certain level or below and goes to step S470. Also, when there is a defect other than the defect of an image, the control section 50 goes to step S470. Here, the control section 50 displays, on a screen of the display section 74, a message or the like to encourage replacement of a part or the like which is a cause of the defect.

When the defect of the image G1 is not at the certain level or below, in step S280, the control section 50 changes a setting value of a setting item A of a part selected on the part selection screen 710 in a direction to increase the setting value. For example, when the setting item A is the “fine adjustment of a developing bias”, to finely adjust the setting value of a voltage of a developing bias, the value is set in a direction to be increased for +2. In such a manner, by setting the setting value of the voltage of the developing bias from a value close to a current setting value, it is possible to check efficiently whether an image is improved. In the present example, a setting condition to make the setting value of the “fine adjustment of a developing bias” higher for +2 is called a second condition.

In step S290, the control section 50 prints an image G2 on the paper P based on the changed setting value of the setting item A. Specifically, as illustrated in FIG. 8B, No. 2 which is identification information 802 to indicate the second condition is printed on the paper P along with the image G2 being printed thereon based on the second condition to change the setting value of the “developing bias” to +2.

In step S300, the reading section 110 reads the image G2 which is on the paper P being fed thereto. In step S310, the control section 50 stores, into the storage section 120, data of the image G2 on the paper P which data is read by the reading section 110.

In step S320, the control section 50 changes the setting value of the setting item A of the part selected on the part selection screen 710 in a direction to decrease the value. For example, when the setting item A is the “fine adjustment of a developing bias”, to finely adjust the setting value of the voltage of the developing bias, the value is set in a direction to be decreased for −2. In the present example, a setting condition to make the setting value of the “fine adjustment of a developing bias” lower for −2 is called a third condition.

In step S330, the control section 50 prints an image G3 on the paper P based on the changed setting value of the setting item A. Specifically, as illustrated in FIG. 8C, No. 3 which is identification information 804 to indicate the third condition is printed on the paper P along with the image G3 being printed thereon based on the third condition to change the setting value of the “fine adjustment of a developing bias” to −2.

In step S340, the reading section 110 reads the image G3 which is on the paper P being fed thereto. In step S350, the control section 50 stores, into the storage section 120, data of the image G3 on the paper P which data is read by the reading section 110.

In step S360, the control section 50 changes the setting values of all setting items back to the original setting values. Specifically, since the current setting value of the “fine adjustment of a developing bias” is −2, the control section 50 changes the setting value of the “fine adjustment of a developing bias” back to “0”.

In step S370, the control section 50 changes a setting value of a setting item B of the part selected on the part selection screen 710 in a direction to increase the value. For example, when the setting item B is the “adjustment of toner density”, to finely adjust the setting value of the toner density, the value is set in a direction to be increased for +4. In the present example, a setting condition to make the setting value of the “adjustment of toner density” higher for +4 is called a fourth condition.

In step S380, the control section 50 prints an image G4 on the paper P based on the changed setting value of the setting item B. Specifically, as illustrated in FIG. 8D, No. 4 which is identification information 806 to indicate the fourth condition is printed on the paper P along with the image G4 being printed thereon based on the fourth condition to change the setting value of the “adjustment of toner density” to “+4”.

In step S390, the reading section 110 reads the image G4 which is on the paper P being fed thereto. In step S400, the control section 50 stores, into the storage section 120, data of the image G4 on the paper P which data is read by the reading section 110.

In step S410, the control section 50 changes the setting value of the setting item B of the part selected on the part selection screen 710 in a direction to decrease the value. For example, when the setting item B is the “adjustment of toner density”, to finely adjust the setting value of the toner density, the value is set in a direction to be decreased for −4. In the present example, a setting condition to make the setting value of the “adjustment of toner density” lower for −4 is called a fifth condition.

In step S420, the control section 50 prints an image G5 on the paper P based on the changed setting value of the setting item B. Specifically, as illustrated in FIG. 8E, No. 5 which is identification information 808 to indicate the fifth condition is printed on the paper P along with the image G5 being printed thereon based on the fifth condition to change the setting value of the “adjustment of toner density” to “−4”.

In step S430, the reading section 110 reads the image G5 which is on the paper P being fed thereto. In step S440, the control section 50 stores, into the storage section 120, data of the image G5 on the paper P which data is read by the reading section 110.

In step S450, the control section 50 displays, on a screen of the operation display section 70, a comparison result between the image G1 printed in the original setting value and each of the images G2, G3, G4, and G5 printed in the changed setting values. Hereinafter, the screen to display the comparison result is called a comparison result screen 730.

Here, the comparison result screen 730 will be described. FIG. 9 is a view illustrating an example of a configuration of the comparison result screen 730. On the comparison result screen 730, a comparison result between the images G2, G3, G4, and G5 and the image G1 is displayed. The images G2, G3, G4, and G5 are printed in a condition, in which a setting value of each setting item such as a “fine adjustment of a developing bias” or an “adjustment of toner density” assigned to the “developing device” to be replaced is made higher and lower. The image G1 is printed in a condition of the original setting value. A comparison item of the images includes toner density, a fog, and in-plane unevenness.

As illustrated in FIG. 9, result information 740 indicating a comparison result between the image G2 printed in the second condition and the image G1 printed in the original first condition is displayed in the setting item of the “fine adjustment of a developing bias”. On the left side of the result information 740, a button 741 to select No. 2 indicating the second condition is displayed. Also, result information 742 indicating a comparison result between the image G3 printed in the third condition and the image G1 printed in the original first condition is displayed in the setting item of the “fine adjustment of a developing bias”. On the left side of the result information 742, a button 743 to select No. 3 indicating the third condition is displayed.

Result information 744 indicating a comparison result between the image G4 printed in the fourth condition and the image G1 printed in the original first condition is displayed in the setting item of the “adjustment of toner density”. On the left side of the result information 744, a button 745 to select No. 4 indicating the fourth condition is displayed. Also, result information 746 indicating a comparison result between the image G5 printed in the fifth condition and the image G1 printed in the original first condition is displayed in the setting item of the “adjustment of toner density”. On the left side of the result information 746, a button 747 to select No. 5 indicating the fifth condition is displayed.

Note that in the present example, a description of the “adjustment of a developing AC frequency” and the “adjustment of a fog margin” which are the setting items of the developing device is omitted. However, as described above, the setting value is changed in a direction to be increased and in a direction to be decreased and images printed according to the changed setting values and the image G1 printed according to the original setting value are compared. Thus, the comparison result can be displayed in such a manner illustrated in FIG. 9.

Referring back to FIG. 7, in step S460, based on the comparison result of the images displayed on the comparison result screen 730, it is determined whether a replacement of a part is necessary. This determination may be performed by a user or may be automatically performed by the control section 50 based on the comparison result. In the following, a case where a user determines whether to replace a part will be described.

For example, when the setting value of the “fine adjustment of a developing bias” of the “developing device” is changed to the second condition, as indicated in the result information 740 illustrated in FIG. 9, toner density of the image G2 becomes higher than that of the image G1, a fog of the image G2 becomes the same with that of the image G1, and in-plane unevenness of the image G2 becomes better than that of the image G1. In such a manner, when an image is printed by making a setting value of each setting item of a part to be replaced higher and lower and a comparison result of toner density or the like is improved from that of the image G1 printed in the original setting value, it is possible to determine that replacement of a part is not necessary.

Also, as illustrated in FIG. 8A to FIG. 8E, it is also possible to determine whether an image is good or bad by checking an image actually printed in each condition on the paper P. For example, when the result information 740 on the comparison result screen 730 is checked with an actual image, by taking out the paper P on which the identification information 800 indicating No. 1 is printed and the paper P on which the identification information 802 indicating No. 2 is printed and by comparing the images G1 and G2 printed on the paper P, it is possible to determine whether the image is improved in the changed setting value.

When it is possible to determine that the replacement of a part is not necessary, a button corresponding to a condition of a setting value of the setting item with which an image is improved is selected on the comparison result screen 730. In the present example, as illustrated in FIG. 9, for example, the button 741 corresponding to the second condition of the “fine adjustment of a developing bias” is selected. When the button corresponding to the condition is selected, the control section 50 reflects the changed setting value of each setting item on subsequent printing of an image. That is, an image is printed by controlling the image forming section 10 or the like with the changed setting value (such as voltage of developing bias +2) of each setting item.

On the other hand, different from the comparison result illustrated in FIG. 9, in a case where toner density, a fog, or the like of each setting item is not improved on the comparison result screen 730 even when of a setting value of each setting item of a part to be replaced is changed to a condition, it is determined that replacement of apart or the like is necessary. This is because a defect of an image may not be solved unless apart is replaced. In this case, processing goes to step S470.

In step S470, for example, a part is replaced by a service person or the like. When a part to be replaced is a developing device, four Y, M, C, and K developing devices 4 surrounded by the dashed line in FIG. 1 are replaced. When a part of a drum unit, an electrifier 2, or the like other than the developing device 4 is to be replaced, it is determined whether the replacement of a part is necessary in a method similar to that of the developing device 4.

Note that in the present example, an example in which four Y, M, C, and K developing devices 4 are replaced has been described but is not a limitation. In respect to each developing device 4, it may be determined whether replacement is necessary by changing a setting value of a setting item in each color of the developing devices 4 and by comparing images before and after a change in the setting value. When it is determined that the replacement is necessary, only the developing device 4 of the color may be replaced.

In the above embodiment, as illustrated in FIG. 8, images are printed on different pieces of paper P with a piece of paper for each condition. However, this is not a limitation. For example, the control section 50 can also print, on one piece of paper P, an image printed in an original setting value at selection of a part or the like and an image printed in a changed setting value.

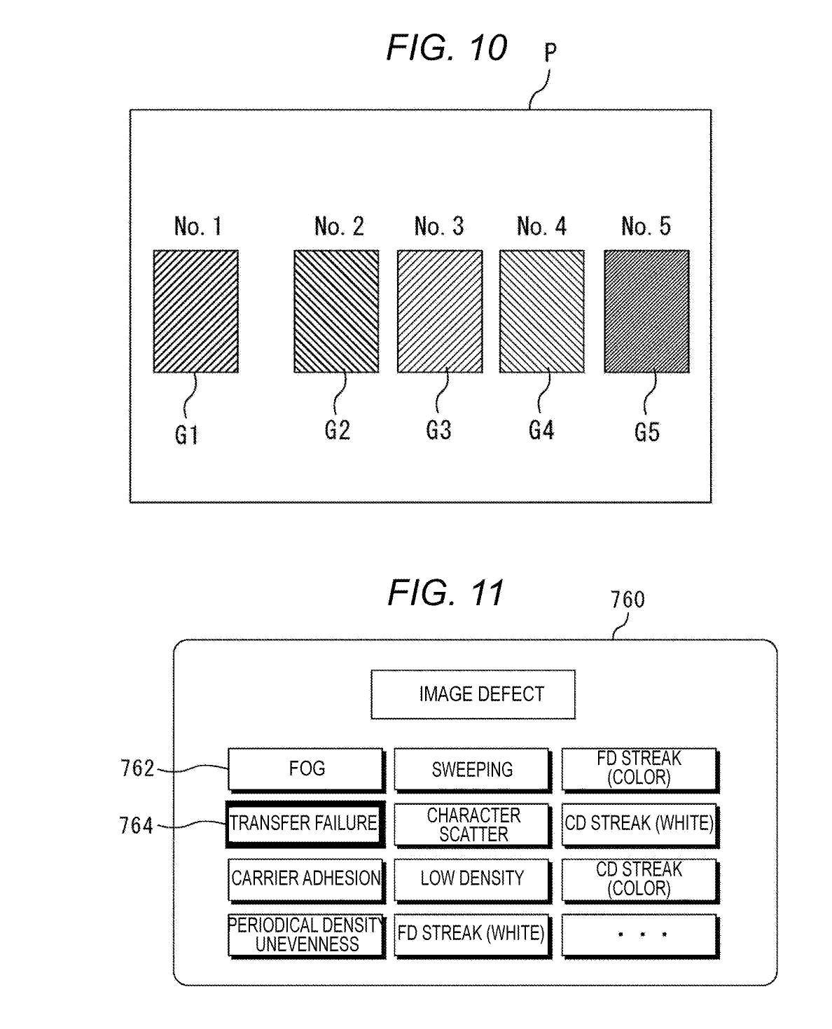

FIG. 10 is a view for describing a case where a plurality of images is printed on one piece of paper P. As illustrated in FIG. 10, the control section 50 prints the image G1 based on the original setting value and the images G2, G3, G4, and G5 based on the changed setting values side by side on one piece of paper P. Note that the number of images printed on one piece of paper P can be arbitrarily set. Thus, since it is possible to compare a plurality of images while actually looking at the plurality of images, it is possible to determine easily and quickly whether a defect of the image is improved.

As described above, according to the second embodiment, in the replacement of a part or the like of when a defect of an image is caused, the image G1 is printed according to a current setting value and the images G2, G3, G4, and G5 are printed according to changed setting values. Thus, it is possible for a user to determine whether an image is improved while actually comparing the images before and after the change in the setting value of each setting item. Also, since a comparison result between the images before and after the change in the setting value is displayed on the display section 74, it is possible to determine whether an image is improved by looking at the comparison result on the comparison result screen 730. Thus, since an opportunity to determine whether replacement of a part or the like is necessary can be given, it is possible to prevent a part or the like from being replaced lightly even when a defect of an image is caused. As a result, unnecessary replacement of a part or the like can be reduced and a cost can be further reduced.

Also, according to the second embodiment, identification information is assigned to each condition of a setting value of each setting item and identification information displayed on the comparison result screen 730 and identification information printed on the paper P are associated with each other. Thus, it is possible to check a comparison result on the screen and an actual image on the paper P while easily associating the result and the image.

Moreover, according to the second embodiment, by using the information processing apparatus 200, a service person staying in an off-site service base can also check a comparison result between images before and after a change in a setting value of a part to be replaced. Thus, information similar to that of a service person on the site can be shared. Also, by using the information processing apparatus 200 and executing a part replacement mode, it is possible to determine, from the service base, whether replacement of a part or the like is necessary. Thus, work efficiency can also be improved.

### Third Embodiment

The third embodiment is different from the first embodiment and the second embodiment in a point that a defect selection screen indicating a defect of an image or the like is displayed by a control section 50 before a part selection screen is displayed when a part replacement mode is selected. Note that other configurations and operations of an image forming apparatus 100C are similar to those in the first embodiment. Thus, the same reference sign is assigned to common configuration elements and a detail description thereof is omitted.

### Example Operation of Image Forming Apparatus

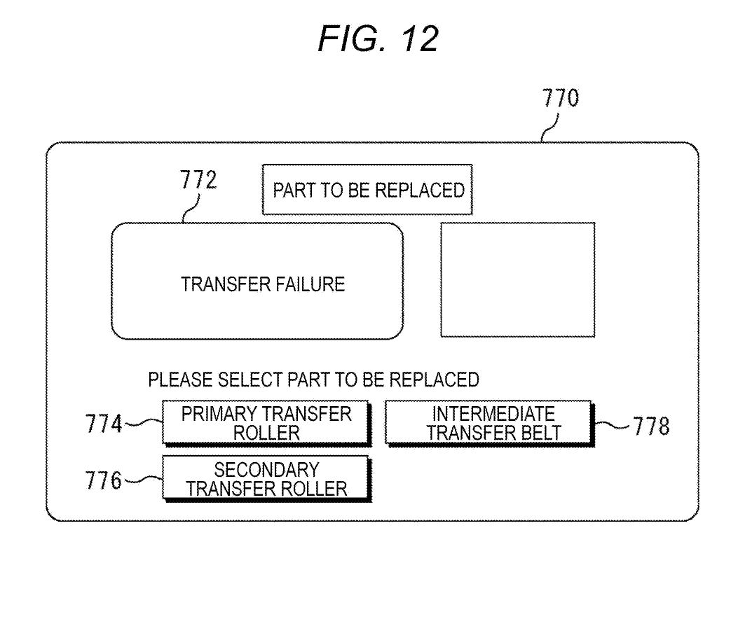

In the following, an example operation of the image forming apparatus 100C according to the third embodiment will be described. FIG. 11 is a view illustrating an example of a configuration of a defect selection screen 760. FIG. 12 is a view illustrating an example of a configuration of a part selection screen 770.

When a button 706 corresponding to a “part replacement mode” is selected on the operation screen 700 illustrated in FIG. 4, the control section 50 displays a defect selection screen 760 on an operation display section 70. The defect selection screen 760 is a screen to display a list of a plurality of possible defects.

As illustrated in FIG. 11, on the defect selection screen 760, a button 762 to select a “fog”, a button 764 to select “transfer failure”, or the like is displayed. Other than the above buttons, buttons to select names of defects such as carrier adhesion, periodical density unevenness, sweeping, character scatter, low density, an FD streak (white), an FD streak (color), a CD streak (white), and a CD streak (color) are displayed. Note that the defects are not limited to what is illustrated in FIG. 11.

Next, when a button corresponding to a defect of an image which is currently caused is selected on the defect selection screen 760, the control section 50 displays the part selection screen 770 on the operation display section 70. In the present example, a case where a button 764 corresponding to the “transfer failure” is selected as a defect of an image will be described.

The part selection screen 770 is a screen to display a part or a unit which can be considered as a selected defect. As illustrated in FIG. 12, on the part selection screen 770, description information 772 to describe contents of the “transfer failure” selected on the defect selection screen 760 and a plurality of selection buttons to select a part or the like to be replaced to solve the “transfer failure” are displayed. As the selection buttons, for example, a button 774 to select a “primary transfer roller”, a button 776 to select a “secondary transfer roller”, and a button 778 to select an “intermediate transfer belt” are displayed. Note that a part to be replaced is not limited to what is illustrated in FIG. 12.

Next, when a button corresponding to a part or the like to be replaced is selected on the part selection screen 770, the control section 50 compares an image printed in an original setting value of a setting item of a selected part or the like with an image printed in a changed setting value. Then, the control section 50 displays a comparison result screen 730 illustrated in FIG. 9 on the operation display section 70. An operation of the image forming apparatus 100C after the selection of a part or the like to be replaced is similar to the processing from step S240 to step S470 illustrated in FIG. 7, and thus, a description thereof is omitted.

As described above, in the third embodiment, by selecting a defect on the defect selection screen 760, a list of parts or the like related to the defect is displayed on the part selection screen 770. Thus, even when a user does not know an exact name of a part or the like related to a defect, by selecting a name of a defect, a part or the like related to the defect can be easily selected. As a result, a mistake in selection of a part or the like to be replaced can be prevented securely.

According to the above embodiments of the present invention, an image is printed based on a changed setting value of a part or a unit selected in a prescribed mode. Thus, by checking the printed image, it is possible to determine whether an image is improved.

Note that a technical scope of the present invention is not limited to the above described embodiments and various modifications may be made thereto within the spirit of the present invention.

Although the present invention has been described and illustrated in detail, it is clearly understood that the same is by way of illustration and example only and is not to be taken by way of limitation, the scope of the present invention being interpreted by terms of the appended claims.

What is claimed is:

1. An image forming apparatus comprising:
a reception section configured to receive a prescribed mode;
a display section configured to display a plurality of parts or units based on the prescribed mode received by the reception section; and
an image forming section configured to change a setting value of a setting item and to print an image on apiece of paper when any one of the plurality of parts or units displayed on the display section is selected, the setting item being assigned to the selected part or unit.

2. The image forming apparatus according to claim 1, wherein when the part or unit is selected, the image forming section prints an image based on a setting value of the setting item of the part or unit at the selection.

3. The image forming apparatus according to claim 1, wherein the image forming section changes a setting value of the setting item of the selected part or unit at the selection in a higher direction and a lower direction and prints a plurality of images.

4. The image forming apparatus according to claim 1, wherein the prescribed mode is a mode to determine whether it is necessary to replace the part or unit.

5. The image forming apparatus according to claim 2, further comprising:
a reading section configured to read an image printed based on the setting value of the part or unit at the selection and an image printed based on the changed setting value; and
a control section configured to compare the plurality of images, which is printed respectively in the setting values and is read by the reading section, and to display the comparison result on the display section.

6. The image forming apparatus according to claim 5, further comprising a communication section configured to transmit, to an information processing apparatus through a network, selection information indicating the selected part or unit and comparison result information indicating the comparison result of the selected part or unit.

7. The image forming apparatus according to claim 2, wherein the control section controls the image forming section to print, on one piece of paper, an image printed according to the setting value at the selection and an image printed according to the changed setting value.

8. The image forming apparatus according to claim 1, wherein when the prescribed mode is selected, the image forming section prints a special pattern on the piece of paper.

9. The image forming apparatus according to claim 5, wherein the control section assigns identification information to each condition of the setting value, prints the identification information in a case of printing an image according to the condition, and displays the identification information in a case of displaying the comparison result, the identification information being associated with the comparison result in each condition.

10. The image forming apparatus according to claim 5, wherein the control section controls the image forming section to reflect the changed setting value on subsequent printing of an image.

11. The image forming apparatus according to claim 5, wherein the control section displays a plurality of defects before displaying the parts or units, and when any one of the plurality of defects is selected, the control section displays a part or unit associated with the selected defect.

12. An image forming method comprising:
receiving a prescribed mode;
displaying a plurality of parts or units based on the received prescribed mode; and
changing a setting value of a setting item and printing an image on a piece of paper when any one of the plurality of parts or units is selected, the setting item being assigned to the selected part or unit.

13. A non-transitory recording medium storing a computer readable program, the program causing a computer served as an image forming apparatus to execute the processing comprising:
a) receiving a prescribed mode;
b) displaying a plurality of parts or units based on the received prescribed mode; and
c) changing a setting value of a setting item and printing an image on a piece of paper when any one of the plurality of parts or units is selected, the setting item being assigned to the selected part or unit.
